(19) United States
(12) Patent Application Publication
(10) Pub. No.: US 2022/0079136 A1
(43) Pub. Date: Mar. 17, 2022

(54) RODENT REPELLANT

(71) Applicant: CHAO HE, Shenzhen (CN)

(72) Inventor: CHAO HE, Shenzhen (CN)

(21) Appl. No.: 17/022,819

(22) Filed: Sep. 16, 2020

(51) Int. Cl. A01M 29/10; F21S 10/06; F21V 5/04; F21V 23/04; A01M 29/18; H04R 1/02

(52) U.S. Cl. CPC A01M 29/10; F21S 10/063; F21V 5/04; A01M 2200/00; A01M 29/18; H04R 1/025; F21V 23/0457

(57) ABSTRACT

A rodent repellant device that is placed on the floor and emits a movable light beam in the local area causing rodents to flee. The light source is operable to move within the plane parallel to the floor and the light beam remains within a selected angle. The selected angle of the light beam is within 90 degrees and may be controlled using a convex lens. In this manner the light beams are prevented from reaching human eye level and disturbing human activity. The light source may be an array of light sources mounted on top of a body and positioned to emit light beams in 360 degrees. The device may incorporate ultrasonic speakers to maximize disturbance to rodents, and elements such as light sensors so that the device operates at night when rodents are active.

### FIELD OF THE INVENTION

The invention lies in the field of rodent prevention.

### SUMMARY

Rodents, pests and other vermin attack fruit and vegetable plants, steal foods, leave unsightly waste and are generally unwanted visitors to many places. People resort to various methods to trap or kill them, or to prevent their arrival in the first place.

The invention is an electronic rodent repelling device that provides a constantly moving, flashing light display to prevent rodents from adapting to the environment of a fixed location, thus interfering with their foraging ability and enhancing the efficiency of driving them away.

### BRIEF DESCRIPTION OF THE DRAWINGS

Embodiments of the present technology will be described and explained through the use of the accompanying drawings. The same reference numbers in different drawings may identify the same or similar elements.

FIG. 1 is a front perspective view of the device.

FIG. 2 is a front perspective view of the device, partially exploded.

FIG. 3 is a close-up perspective view of a light module.

FIG. 4 is a rear perspective view of the device, partially exploded.

FIG. 5A is a schematic diagram showing elements in a light assembly.

FIG. 5B is a schematic diagram showing elements in a light assembly.

FIG. 6 is a close-up perspective view of a light assembly.

FIG. 7 is a schematic diagram showing a position of the device in a room.

The drawings, some components and/or operations can be separated into different blocks or combined into a single block when discussing some embodiments of the present technology. Moreover, while the technology is amenable to various modifications and alternative forms, specific embodiments have been shown by way of example in the drawings and are described in detail below. The intention, however, is not to limit the technology to the particular embodiments described herein. On the contrary, the technology is intended to cover all modifications, equivalents, and alternatives falling within the scope of the technology as defined by the appended claims.

### DETAILED DESCRIPTION

The embodiments set forth below represent the necessary information to enable those skilled in the art to practice the embodiments and illustrate the best mode of practicing the embodiments. Upon reading the following description in light of the accompanying figures, those skilled in the art will understand the concepts of the disclosure and will recognize applications of these concepts that are not particularly addressed herein. It should be understood that these concepts and applications fall within the scope of the disclosure and the accompanying embodiments.

The purpose of the terminology used herein is only for describing embodiments and is not intended to limit the scope of the disclosure. Unless defined otherwise, all terms of art, notations and other scientific terms or terminology used herein have the same meaning as is commonly understood by one of ordinary skill in the art to which this disclosure belongs. In some cases, terms with commonly understood meanings are defined herein for clarity and/or for ready reference, and the inclusion of such definitions herein should not necessarily be construed to represent a substantial difference over what is generally understood in the art. All patents, applications, published applications and other publications referred to herein are incorporated by reference in their entirety. If a definition set forth in this section is contrary to or otherwise inconsistent with a definition set forth in the patents, application, published applications and other publications that are herein incorporated by reference, the definition set forth in this section prevails over the definition that is incorporated herein by reference.

Where context permits, words using singular or plural form may also include the plural or singular form, respectively. As used herein, “a” or “an” means “at least one” or “one or more.” As used herein, the term “user”, “subject”, “end-user” or the like is not limited to a specific entity or person. For example, the term “user” may refer to a person who uses the systems and methods described herein, and frequently may be a technician. However, this term is not limited to end users or technicians and thus encompasses a variety of persons or entities who can use the disclosed systems and methods.

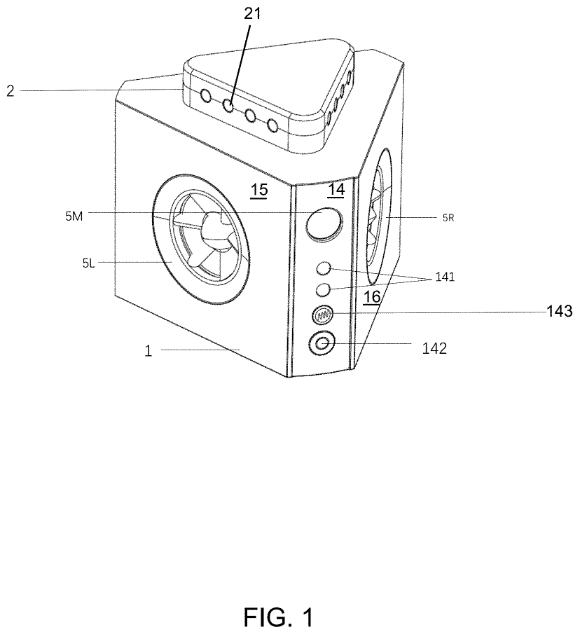

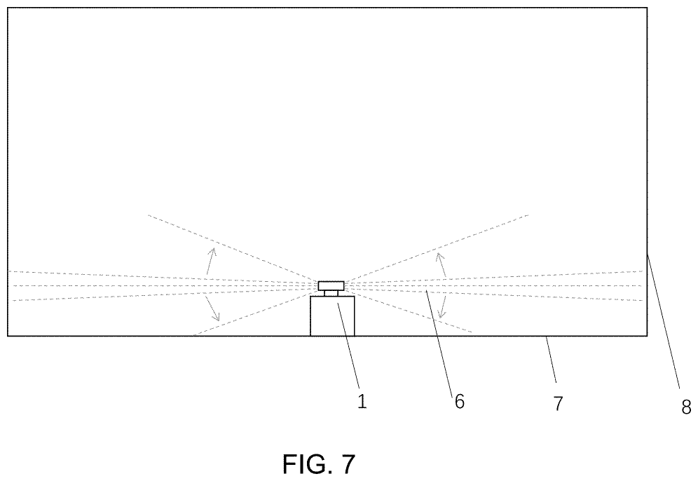

FIG. 1 is a front perspective view of the device. The device comprises a light module [2] and driven by a motor [3] such that the light module [2] is operable to continuously change the position of one or more light sources [21] emanating from said light module [2]. In this manner, the beams [6] from light sources [21] scan the local area, temporarily blinding the eyes of rodents, causing them to flee. Light from the light sources [21] are limited to controlled, focused beams of light [6], and since the device is placed on the floor or ground, human activity is not affected. FIG. 7 is a schematic diagram showing how the device would be placed on a floor [7], with light beams [6] remaining within a selected angle so that they do not reach human eyes.

The light module [2] is operable to oscillate or rotate such that it is continuously changing position, thereby changing the direction of the light emanating from light sources [21] and maximizing the disruption to rodents in the area. The light module [2] can rotate continuously, rotate back and forth at different intervals, oscillate back and forth around a fixed point, or any other form of movement. The movement of the light module [2] is limited to the plane of the one or more light sources [21] substantially within the plane parallel to the floor, so that light beams do remain within the selected angle minimizing disruption to human activity. The representative embodiment depicted in the drawings shows the light module [2] mounted on the top of a body [1] but the light module [2] may be a standalone device, or it can be integral with the body [1], mounted on the side of the body [1], mounted apart from the body [1], or positioned or integrated in other configurations.

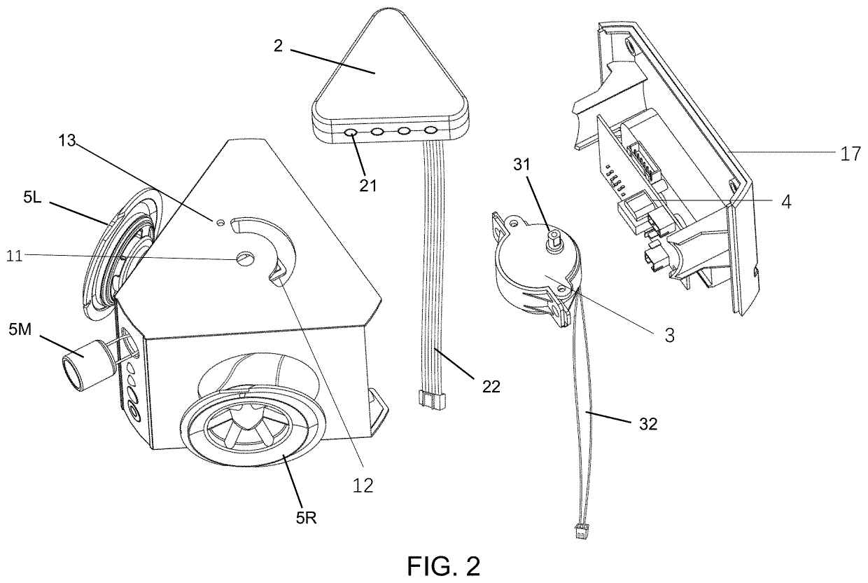

FIG. 2 is a top perspective view of a representative embodiment of the device, partially exploded, showing how such a device can be constructed. For instance, the light module [2] can be coupled to a gear motor [3] secured within body [1] and operatively coupled to the light module [2] through an opening [11] on a top panel of the body [1], whereby the gear motor [3] causes the light module to oscillate back and forth around fixed axis [31]. LEDs [21] on the light module [2] may be operatively coupled, for instance via wires [22] through opening [12], to an electronic circuit board [4] secured within the body [1]. The electronic circuit board [4] may comprise a microcontroller that operates the lights [21] and motor [3]. For instance, motor [3] may be connected to circuit board [4] via wires [32]. An opening [13] on the top panel of the body can facilitate placement of a sensor to detect the position of light module [2], for automatic electronic control of the light module [2].

Light sources [21] may emit light in any colors or frequencies without limitation. For example, ultraviolet light may be emitted. Focused ultraviolet rays can kill viruses brought on by the rodents, and at the same time may harm the retinas of the rodents, causing temporary blindness. The lights [21] may be operated to emit light at different speeds, such as in sudden, strobing flashes, or other intermittent speeds. Particularly when operated in the dark, the flashes of light can cause fast dilation and contraction of the rodents' pupils and thus temporary blindness, causing them to panic and flee the area. Using a microcontroller, light sources [21] may be programmed to each emit different colors at different patterns and speeds, maximizing confusion to the rodents. When strobes are followed by long-duration cycles, the rodents will stay out of the area.

The device may also comprise one or more speakers [5] capable of emitting sounds at multiple frequencies, including high frequencies and ultrasonic sound, i.e. frequencies from 10 KHz to 100 KHz. These may be two-in-one ultrasound and ordinary speakers. These sounds further frighten and confuse the rodents and cause them to flee. Speakers [5] may be located in various locations on the device. In the embodiment depicted in FIGS. 1-2 and 4, speakers [5L] and [5R] are located on left [15] and right [16] side panels of the body [1], respectively, while a third speaker [5M] is located on a front panel [14] positioned between the left and right side panels. Speakers [5L] and [5R] may be wide angle speakers while central speaker [5M] may be a directional ultrasonic bundle. Such configuration maximizes the sound coverage of this example.

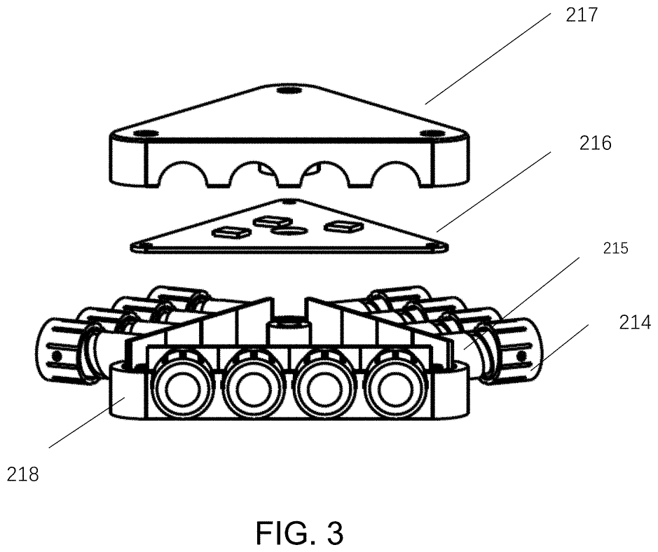

Light sources [21] may be positioned around the entire perimeter of light module [2], such that light emanates in 360 degrees around the device. For instance, the light module [2] could be circular with light sources [21] placed around its perimeter. In the embodiment shown in FIGS. 1-4, the light module [2] is a triangle shape with an array of lights [21] on each side of the triangle, mounted on top of the body [1], and the body [1] is also substantially triangular, although both body and light module may be a wide variety of shapes. For example, as shown in FIG. 3, the light module [2] may comprise a triangle shape with an array of lights arranged on each of its three sides, the array of lights operatively connected to a circuit board [216] whereby each light can be operated, and held together between cover [217] and base [218].

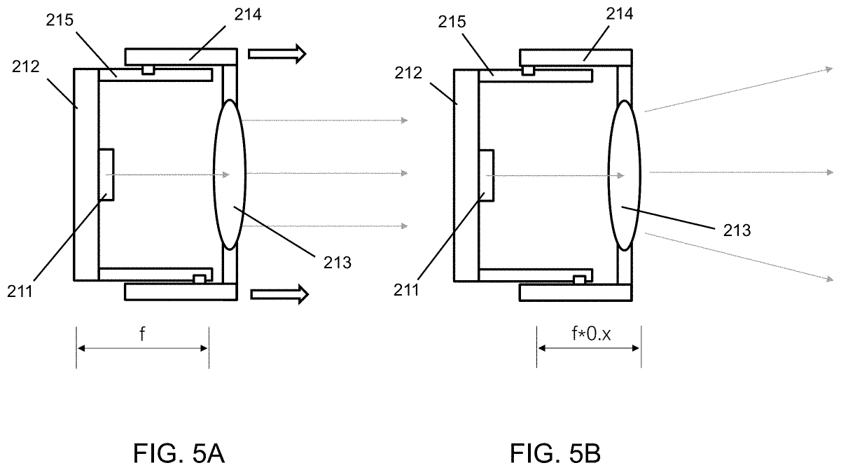

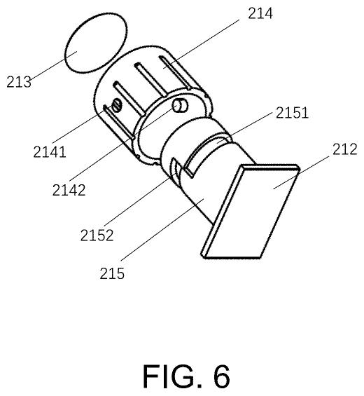

Light sources [21] emit light beams limited to a selected angle. Light sources may comprise spotlights in which light beams are limited to a selected angle and/or may comprise a convex lens to control the selected angle of the light beam. The selected angle may be any angle within 90 degrees. FIGS. 5A and 5B and FIG. 6 show examples in which a convex lens [213] is operable to control the selected angle of the light beams. For example, LED [211] mounted on circuit board [212] is positioned behind a convex lens [213] positioned so that the light beam emitted by LED [211] emerges as parallel light beams through the convex lens [213]. Convex lens [213] may be mounted on a movable assembly [214] movably coupled to light well [215]. For example, movable assembly [214] may be movably coupled around the outside of light well [215] by one or more interior pins [2141], [2142] fitting into one or more cam slots [2151], [2152] around the perimeter of light well [215]. In this manner, convex lens [213] is operable to move towards and away from light source [211] to narrow and widen the angle of the light beam [6] emerging from the convex lens [213].

The device may comprise additional operational elements such as informational lights [141] and buttons [142] for operating the device. For instance, the device may comprise a photosensitive sensing element [143] on the exterior of the device, such as a photosensitive resistor or photodiode so that the lights [21] switch off during daylight when the rodents are not active.

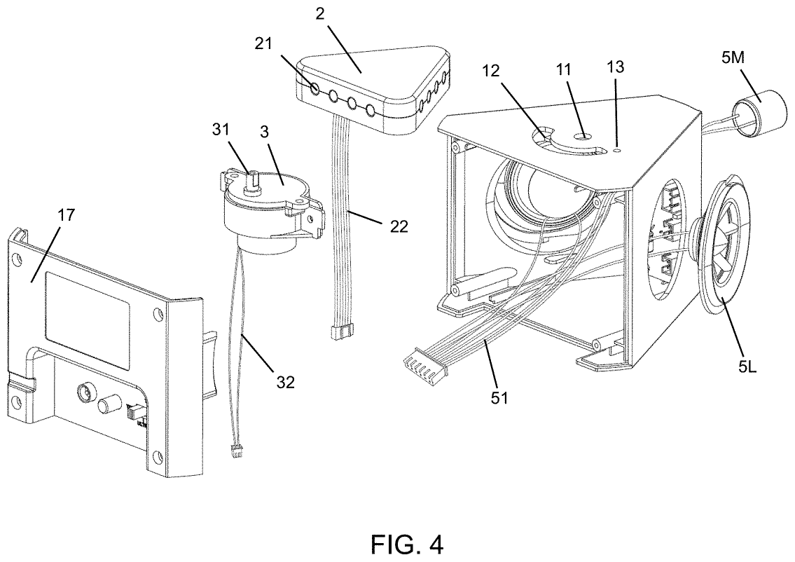

FIG. 4 is a rear perspective view of the device, partially exploded. The rear panel [17] of the body [1] may comprise a power supply outlet, power switch and/or other buttons for operating the device. Various power sources such as batteries or DC power can be included to power the device. Batteries may be rechargeable or chargeable through electrical induction or through a port and cable connecting the device to a power source.

1. An electronic rodent repellant for placement on a floor, comprising:
a light module comprising one or more light sources each operable to emit a light beam within a selected angle, wherein the light module is operable to continuously change position in a plane of the one or more light sources parallel to the floor.

2. The electronic rodent repellant of claim 1 further comprising a body on top of which is mounted the light module, wherein the body houses a motor operatively coupled to the light module.

3. The electronic rodent repellant of claim 2 wherein the one or more light sources is an array of light sources positioned around a perimeter of the light module.

4. The electronic rodent repellant of claim 3 wherein the body is substantially triangular by comprising two side panels attached at their back edge to a back panel, and a front panel of lesser width than the back panel and positioned between a front edge of each of the two side panels.

5. The electronic rodent repellant of claim 4 further comprising an ultrasonic speaker on each side panel.

6. The electronic rodent repellant of claim 2 further comprising an ultrasonic speaker on the body.

7. The electronic rodent repellant of claim 4 wherein the perimeter of the light module is substantially triangular.

8. The electronic rodent repellant of claim 3 wherein the perimeter of the light module is substantially triangular.

9. The electronic rodent repellant of claim 3 further comprising a light sensitive device on an exterior of the body, an electronic circuit board housed within the body, wherein the one or more light sources and the motor are operable to switch off when sufficient light is received by the light sensitive device.

10. The electronic rodent repellant of claim 4 further comprising a light sensitive device on an exterior of the body, an electronic circuit board housed within the body, wherein the one or more light sources and the motor are operable to switch off when sufficient light is received by the light sensitive device.

11. The electronic rodent repellant of claim 5 further comprising a light sensitive device on an exterior of the body, an electronic circuit board housed within the body, wherein the one or more light sources and the motor are operable to switch off when sufficient light is received by the light sensitive device.

12. The electronic rodent repellant of claim 6 further comprising a light sensitive device on an exterior of the body, an electronic circuit board housed within the body, wherein the one or more light sources and the motor are operable to switch off when sufficient light is received by the light sensitive device.

13. The electronic rodent repellant of claim 1 wherein the one or more light sources additionally comprises a convex lens for controlling the selected angle of the light beams, the convex lens mounted at an end of a cylindrical cover covering a cylindrical well.

14. The electronic rodent repellant of claim 3 wherein the one or more light sources additionally comprises a convex lens for controlling the selected angle of the light beams, the convex lens mounted at an end of a cylindrical cover covering a cylindrical well.

15. The electronic rodent repellant of claim 4 wherein the one or more light sources additionally comprises a convex lens for controlling the selected angle of the light beams, the convex lens mounted at an end of a cylindrical cover covering a cylindrical well.

16. The electronic rodent repellant of claim 5 wherein the one or more light sources additionally comprises a convex lens for controlling the selected angle of the light beams, the convex lens mounted at an end of a cylindrical cover covering a cylindrical well.

17. The electronic rodent repellant of claim 9 wherein the one or more light sources additionally comprises a convex lens for controlling the selected angle of the light beams, the convex lens mounted at an end of a cylindrical cover covering a cylindrical well.

18. The electronic rodent repellant of claim 4 further comprising a directional ultrasonic speaker on the front panel.

19. The electronic rodent repellant of claim 5 further comprising a directional ultrasonic speaker on the front panel.

20. The electronic rodent repellant of claim 9 further comprising a directional ultrasonic speaker on the front panel.
